(19) United States
(12) Patent Application Publication
(10) Pub. No.: US 2023/0026243 A1
(43) Pub. Date: Jan. 26, 2023

(54) FISH GRINDER AND REFRIGERATOR

(71) Applicant: Alan Keith Scruggs, Saint Stephens, AL (US)

(72) Inventor: Alan Keith Scruggs, Saint Stephens, AL (US)

(21) Appl. No.: 17/873,314

(22) Filed: Jul. 26, 2022

Related U.S. Application Data
(60) Provisional application No. 63/225,690, filed on Jul. 26, 2021.

(51) Int. Cl. A01K 97/04; F25D 31/00; B02C 21/02; A22C 25/20; A22C 25/08

(52) U.S. Cl. CPC A01K 97/045; F25D 31/006; B02C 21/02; A22C 25/20; A22C 25/08

(57) ABSTRACT

Systems and methods are disclosed for receiving, processing, and storing fish carcasses. A system comprises a conveyor apparatus, a grinding apparatus, a tank, a container, a refrigerating apparatus, and a power source. The power source may comprise at least one solar panel. The system may comprise a payment apparatus. The tank may be removable from the container. The system may be configured to loaded onto a truck. The system may indicate to a user that the tank is nearly full.

### CROSS-REFERENCE TO RELATED APPLICATIONS

This application claims priority to U.S. Provisional Patent Application Ser. No. 63/225,690, titled “FISH GRINDER AND REFRIGERATOR” and filed on Jul. 26, 2021; the specification, drawings, and claims thereof are incorporated herein by reference.

### FIELD OF INVENTION

This disclosure relates generally to systems and methods for processing meat. More specifically, this disclosure relates to systems and methods for receiving, processing, and storing fish carcasses. This disclosure also relates to systems and methods for producing and storing chum.

### BACKGROUND

Fishers often have waste fish carcasses to dispose of at a dock. Laws and regulations often prohibit their dumping the fish carcasses into the water at the dock or otherwise near the shore (e.g., less than three miles from the shore). Systems and methods for receiving, processing, and storing such waste fish carcasses are desirable.

To reduce the time and expense of transporting fish carcasses to a processing facility, it is further desirable to provide such systems and methods that can be used at or near a dock. Conditions at a dock are not favorable for known methods of processing fish carcasses. Docks are outside and may lack indoor space for a processing system. Docks also often lack reliable power sources. Docks also are often distant from large-scale processing plants that could be used to package chum for sale. Docks also are often distant from large-scale rendering plants that could use the processed fish carcasses to make pet food or fertilizer.

### SUMMARY OF THE INVENTION

The present disclosure describes systems and methods for receiving, processing, and storing fish carcasses. In a first embodiment, a system for receiving, processing, and storing fish carcasses is provided and comprises: a conveyor apparatus configured to receive the carcasses; a grinding apparatus configured to receive the carcasses from the conveyor apparatus, wherein the grinding apparatus is configured to grind the carcasses into chum; a tank configured to receive the chum from the grinding apparatus; a container configured to substantially contain the tank, wherein the container is a substantially closed box; a refrigerating apparatus configured to refrigerate the contents of the container; and a power source configured to power the grinding apparatus and the refrigerating apparatus.

In a second embodiment, a system for receiving, processing, and storing fish carcasses is provided and comprises: a conveyor apparatus configured to receive the carcasses; a grinding apparatus configured to receive the carcasses from the conveyor apparatus, wherein the grinding apparatus is configured to grind the carcasses into chum; a tank configured to receive the chum from the grinding apparatus; a container configured to substantially contain the tank, wherein the container is a substantially closed box; a refrigerating apparatus configured to refrigerate the contents of the container; and a power source configured to power the grinding apparatus and the refrigerating apparatus, wherein the power source comprises at least one solar panel.

In a third embodiment, a system for receiving, processing, and storing fish carcasses is provided and comprises: a conveyor apparatus configured to receive the carcasses; a grinding apparatus configured to receive the carcasses from the conveyor apparatus, wherein the grinding apparatus is configured to grind the carcasses into chum; a tank configured to receive the chum from the grinding apparatus; a container configured to substantially contain the tank, wherein the container is a substantially closed box; a refrigerating apparatus configured to refrigerate the contents of the container; a payment apparatus coupled to the conveyor apparatus and to the grinding apparatus and configured to receive payments; and a power source configured to power the grinding apparatus, the refrigerating apparatus, and the payment apparatus.

In a fourth embodiment, a method of receiving, processing, and storing fish carcasses is provided and comprises: receiving carcasses at a conveyor apparatus in a loading position; receiving carcasses from the conveyor apparatus at a grinding apparatus coupled to the conveyor apparatus; by the grinding apparatus, grinding carcasses into chum; receiving the chum at a tank coupled to the grinding apparatus; and, by a refrigerating apparatus, refrigerating the chum in the tank in a container configured to substantially contain the tank, wherein the refrigerating apparatus is coupled to the container.

In a fifth embodiment, a method of receiving, processing, and storing fish carcasses is provided and comprises: receiving payment from a customer at a payment apparatus coupled to the conveyor apparatus; receiving carcasses at a conveyor apparatus in a loading position; receiving carcasses from the conveyor apparatus at a grinding apparatus coupled to the conveyor apparatus; by the grinding apparatus, grinding carcasses into chum; receiving the chum at a tank coupled to the grinding apparatus; and, by a refrigerating apparatus, refrigerating the chum in the tank in a container configured to substantially contain the tank, wherein the refrigerating apparatus is coupled to the container.

The above summary presents a simplified overview to provide a basic understanding of some aspects of the claimed subject matter. This summary is not an extensive overview. It is not intended to identify key or critical elements or to delineate the scope of the claimed subject matter. Its sole purpose is to present some concepts in a simplified form as a prelude to the more detailed description that is presented later.

### BRIEF DESCRIPTION OF THE DRAWINGS

The following drawings are attached to—and form a portion of—this disclosure:

FIG. 1 is a schematic side view of an embodiment of a system for receiving, processing, and storing fish carcasses.

FIG. 2 is a schematic end view of the embodiment of the system of FIG. 1.

FIG. 3 is an end view of the embodiment of the system of FIG. 1, with the conveyor apparatus in a loading position.

FIG. 4 is a view of the embodiment of the system of FIG. 1, with the conveyor apparatus in the loading position.

FIG. 5 is a view of an embodiment of a system for receiving, processing, and storing fish carcasses.

FIG. 6 is a view of an embodiment of a system for receiving, processing, and storing fish carcasses as loaded onto a truck.

FIG. 7 depicts a method of receiving, storing, and processing fish carcasses.

FIG. 8 is an end view (of the end opposite the end shown in FIG. 3) of the embodiment of the system of FIG. 1, with the conveyor apparatus in a loading position.

### DEFINITIONS

Unless otherwise defined, all terms (including technical and scientific terms) in this disclosure have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly defined otherwise in this disclosure. For brevity or clarity, well known functions or constructions may not be described in detail.

The terms “about” and “approximately” shall generally mean an acceptable degree of error or variation for the quantity measured in light of the nature or precision of the measurements. Typical, exemplary degrees of error or variation are within 20 percent (%), preferably within 10%, more preferably within 5%, of a given value or range of values. Numerical quantities given in this description are approximate unless stated otherwise, meaning that the term “about” or “approximately” can be inferred when not expressly stated.

The terminology used throughout the disclosure is for the purpose of describing particular embodiments only and is not intended to be limiting. The singular forms “a,” “an,” and “the” are intended to include the plural forms as well, unless the context clearly indicates otherwise.

The terms “first,” “second,” and the like are used to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the disclosure. Likewise, terms like “top” and “bottom”; “front” and “back”; and “left” and “right” are used to distinguish certain features or elements from each other, but it is expressly contemplated that a top could be a bottom, and vice versa.

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

The terms “connected to,” “coupled to,” “coupled with,” “in connection with,” “in operative communication with,” “in communication with,” or “connecting” include any suitable connection, coupling, or communication, including mechanical connection, electrical connection (e.g., one or more wires), or signal-conducting channel (e.g., Bluetooth®, Near-Field Communication (“NFC”), or other inductive coupling or radio-frequency (“RF”) link).

The term “processor” may include one or more processors having processing capability necessary to perform the processing functions described herein, including but not limited to hardware logic, computer readable instructions running on a processor, or any suitable combination thereof. A processor may run software to perform the operations described herein, including software accessed in machine readable form on a tangible non-transitory computer readable storage medium, as well as software that describes the configuration of hardware such as hardware description language (“HDL”) software used for designing chips.

The term “signal” means any suitable signal, for example a voltage, a current, a duty cycle, a frequency or amplitude of electrical, electromagnetic, or optical oscillation, or a mechanical signal (e.g., pressure, vibration, a tap, or other mechanical signal) in some embodiments.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

The following description illustrates and describes the processes, machines, manufactures, compositions of matter, and other teachings of the present disclosure. The disclosure shows and describes only certain embodiments of the processes, machines, manufactures, compositions of matter, and other teachings disclosed; but as mentioned above, it is to be understood that the teachings of the present disclosure are capable of use in various other combinations, modifications, and environments and are capable of changes or modifications within the scope of the teachings of this disclosure, commensurate with the skill and knowledge of a person having ordinary skill in the relevant art.

The embodiments described are further intended to explain certain preferred modes of practicing the processes, machines, manufactures, compositions of matter, and other teachings of the disclosure and to enable others skilled in the art to utilize the teachings of the disclosure in such, or other, embodiments and with the various modifications required by the particular applications or uses. Accordingly, the processes, machines, manufactures, compositions of matter, and other teachings of the present disclosure are not intended to limit the embodiments and examples disclosed herein. Any section headings herein are provided only for consistency with the suggestions of 37 C.F.R. § 1.77 or otherwise to provide organizational cues. These headings shall not limit or characterize the invention(s) set forth herein.

### DETAILED DESCRIPTION

Systems and methods have been developed and are herein described at least: for receiving, processing, and storing fish carcasses; for producing and storing chum; for producing and storing chum in a transportable container; and for transporting systems for accomplishing the foregoing. In addition to the description herein and in the accompanying drawings, additional detail is contained in U.S. Provisional Patent Application Ser. No. 63/225,690—titled “FISH GRINDER AND REFRIGERATOR” and filed on Jul. 6, 2021—which is hereby incorporated by reference into the specification in its entirety.

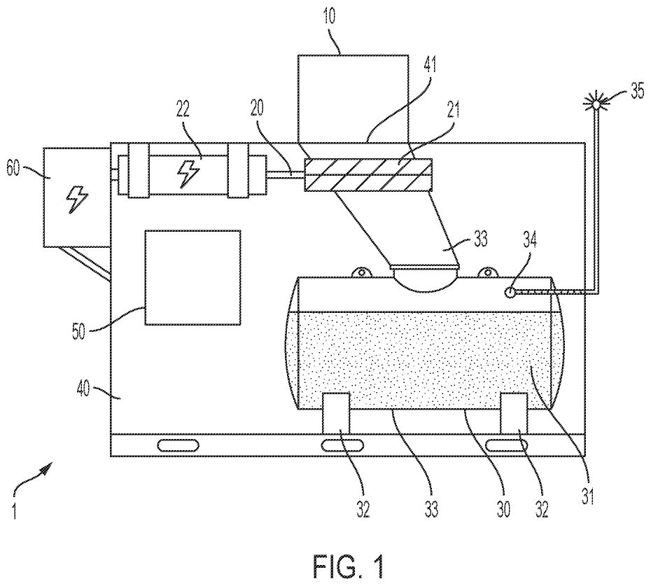

FIG. 1 shows a schematic side view of an embodiment of a system 1 for receiving, processing, and storing fish carcasses. The system comprises a conveyor apparatus 10, a grinding apparatus 20, a tank 30, a container 40, and a refrigerating apparatus 50.

The conveyor apparatus 10 is configured to receive carcasses (not shown). The conveyor apparatus 10 is a chute through which carcasses move. As carcasses pass through the conveyor apparatus 10, the carcasses pass through the grinding apparatus 20. The grinding apparatus 20 is configured to receive carcasses from the conveyor apparatus 10. The grinding apparatus 20 is configured to grind or pulverize the carcasses into small pieces (“chum”). The grinding apparatus 20 comprises a grinder 21 and a motor 22 configured to drive the grinder 21. A power source 60 supplies power to the motor 22. The power source 60 may be any suitable power source. The grinder 21 may be any suitable meat grinder or other grinder. Some examples of a grinder 21 include the TASKMASTER series of grinders available from Franklin Miller, Inc. The motor 22 may be any suitable motor. The motor 22 may be an alternating-current—driven motor or a direct-current—driven motor.

After the grinding apparatus 20, the chum is moved (e.g., by gravity or by the grinding apparatus 20) through the remainder of the conveyor apparatus 10 to the tank 30. The tank 30 is coupled to the conveyor apparatus 10. The tank 30 may be removably and repeatably coupled to the conveyor apparatus 10 by a hose 33. The tank 30 and hose 33 may be attached together by a quick-release attachment mechanism (not specifically shown). The tank 30 is configured to receive and hold chum 31. The tank 30 may be any suitable tank. The tank 30 may be a plastic tank. The tank 30 may be configured to hold up to approximately one-thousand gallons of chum. The tank 30 may be of any suitable size or capacity. The tank 30 may comprise or be adapted to attach to at least one skid 32 (e.g., two skids 32 as shown in FIG. 1) at the bottom 33 of the tank 30. The at least one skid 32 allows for a forklift (not shown) to move the tank 30 into and out of the container 40. The tank 30 comprises a tank-level sensor 34 connected to a tank-level indicator 35. The tank-level sensor 34 is configured to detect when the amount of chum 31 in the tank 30 has reached a pre-determined level (e.g., ninety-percent of the capacity of the tank 30). Examples of a tank-level sensor 34 includes the LR36, LR41, and LR46 ECHOPRO line of radar solids level sensors available from Flowline, Inc. The tank-level indicator 35 is configured to indicate (e.g., by a blinking light or by transmitting a signal to a receiver (not specifically shown)) that the tank-level sensor 34 has detected that the amount of chum 31 in the tank 30 has reached the pre-determined level. The tank-level indicator 35 may be outside the container, so that anyone can see when the tank 30 is full or nearly full or has reached the pre-determined level and then notify the owner, operator, or maintainer of the system. Instructions for contacting the owner, operator, or maintainer of the system may be displayed—for example on a sign—near the tank-level indicator 35. The tank-level indicator 35 may send a signal to a cloud-based server that can be accessed by a mobile app or web app. The tank 30 may also have a pressure sensor (not specifically shown) or a pressure release valve (not specifically shown) or both.

The container 40 is configured to substantially contain the grinding apparatus 20 and the tank 30. The container 40 partially contains the conveyor apparatus 10. The container 40 is a substantially closed box. The container may be approximately ten feet tall, approximately twelve feet long, and approximately eight feet wide. The container 40 may be any suitable container of any suitable size or capacity. The container 40 has a hole 41 through which the conveyor apparatus 10 passes and through which the carcasses move as they move on the conveyor apparatus 10.

The refrigerating apparatus 50 is configured to refrigerate the contents of the container 40. For example, the refrigerating apparatus 50 is configured to refrigerate the tank 30 and chum 31. The refrigerating apparatus 50 is configured to refrigerate the contents of the container 40 to a temperature that will slow or prevent spoilage of the chum 31, including microbial spoilage of the chum 31 due to bacteria (aerobic and anaerobic), yeasts, and molds. The refrigerating apparatus 50 may be configured to refrigerate the contents of the container 40 to a temperature below approximately 47 degrees Fahrenheit, for example to a temperature between approximately 32 degrees Fahrenheit and approximately 47 degrees Fahrenheit. In some embodiments, the refrigerating apparatus 50 is configured to refrigerate the contents of the container 40 to a temperature between approximately 40 degrees Fahrenheit and approximately 45 degrees Fahrenheit. The temperature may be selected to slow or prevent spoilage of the chum 31 without causing freezing of the chum 31. The refrigerating apparatus 50 is an air-conditioning apparatus mounted to an external side of the container 40. Examples of a refrigerating apparatus 50 includes the FUSION-TEC line of exterior wall-mount air-cooling systems available from Bard Manufacturing Company, Inc. The refrigerating apparatus 50 may be any suitable refrigerating apparatus and may be coupled to the container 40 at any suitable position and by any suitable coupling. The power source 60 supplies power to the refrigerating apparatus 50.

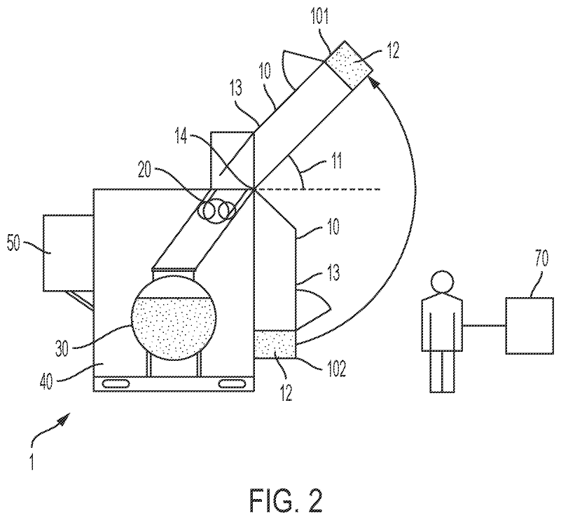

FIG. 2 shows a schematic end view of the embodiment of system 1 of FIG. 1. The conveyor apparatus 10 is configured to be movable between a conveying position 101 and a loading position 102. In the conveying position 101, an external chute 13 of the conveyor apparatus 10 is angled from the horizontal by an angle 11. The angle 11 is configured to allow a force of gravity to move carcasses through the conveyor apparatus. For example, the angle 11 may be approximately seventy degrees.

In the loading position 102, the conveyor apparatus 10 is configured such that a loading end 12 of the conveyor apparatus 10 is in a position to receive carcasses. For example, as shown in FIG. 2, in the loading position 102 the external chute 13 of the conveyor apparatus 10 is positioned vertically with the loading end 12 approximately three feet above the ground.

The conveyor apparatus 10 is hinged at a hinge 14 around which the external chute 13 pivots between the conveying position 101 and the loading position 102. An electric cylinder or other suitable actuator (not specifically shown) is coupled to the power source 60 (see FIG. 1) and moves the conveyor apparatus 10 between the conveying position 101 and the loading position 102.

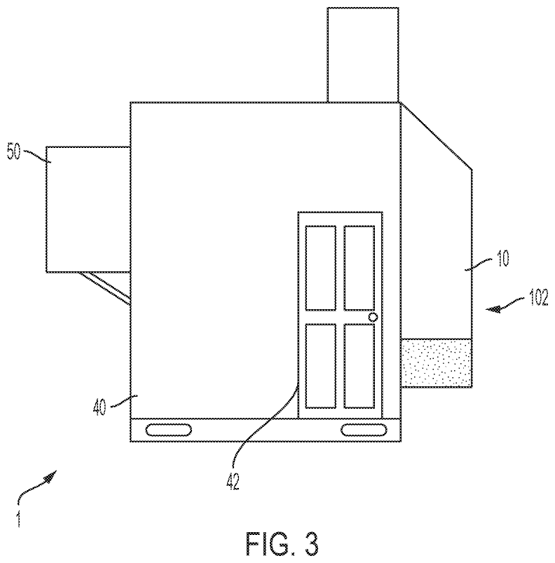

FIG. 3 shows an end view of the embodiment of system 1 of FIG. 1, with the conveyor apparatus 10 in a loading position 102. The container 40 comprises a user door 42. The user door 42 is configured to admit maintenance personnel or other persons into the container 40.

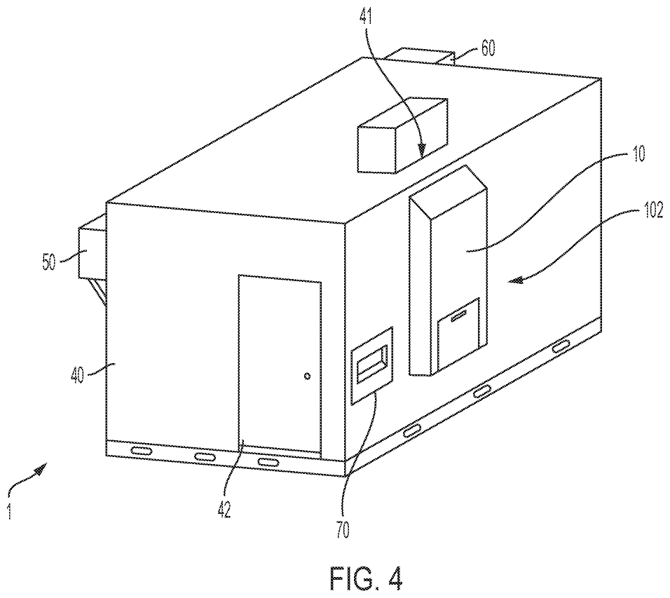

FIG. 4 shows a view of the embodiment of system 1 of FIG. 1, with the conveyor apparatus 10 in the loading position 102. The system 1 may comprise a payment apparatus 70 coupled to the conveyor system 10, to the grinding mechanism 20, and to the power source 60 (see FIG. 1). The payment apparatus 70 is a vending kiosk configured to receive payments from a customer. The payment apparatus 70 may be configured to receive credit-card payments, debit-card payments, cash payments, customized tokens, or any other suitable payment method. The payment apparatus 70 is configured to send a signal to the conveyor apparatus 10 to move the conveyor apparatus 10 between the loading position 102 and the conveyor position 101 (see FIG. 2). The payment apparatus 70 is configured to send a signal to the grinding apparatus 20 to switch the grinding apparatus 20 between an “on” state and an “off” state.

The payment apparatus 70 may comprise payment-processing hardware and/or software that receives or retrieves a user's payment information—for instance from a user's payment device (e.g., card or mobile device)—then transmits the information to a merchant payment provider. The payment provider may then transmit the information to a payment-card network/issuer. Then the payment-card provider makes a payment in a merchant's bank account and charges the amount, e.g. to the user's credit card bill or as a withdrawal from a user's account (e.g., a bank account, VENMO account, or PAYPAL account). The payment apparatus 70 may be physically integral with the container 40 or it may be separate from the container 40.

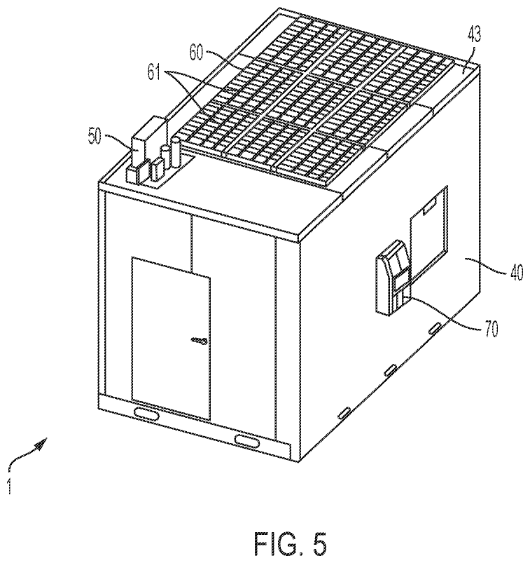

FIG. 5 shows a view of an embodiment of system 1 for receiving, processing, and storing fish carcasses. The container 40 may be approximately ten-and-one-half feet tall, approximately fifteen feet long, and approximately eight-and-one-half feet wide. The refrigerating apparatus 50 is mounted on a top 43 of the container 40.

The power source 60 may comprise at least one solar panel 61. The solar panels 61 may be positioned on the top 43 of the container 40. The solar panels 61 may be configured to be the primary source of power to the system 1. The solar panels 61 may be configured to be a secondary (or back-up) source of power to the system 1. The solar panels 61 are configured to supply enough power to power the refrigerating apparatus 50. The solar panels 61 may be configured to supply enough power to power the conveyor apparatus 10 (see FIG. 1), the grinding apparatus 20 (see FIG. 1), and the payment apparatus 70.

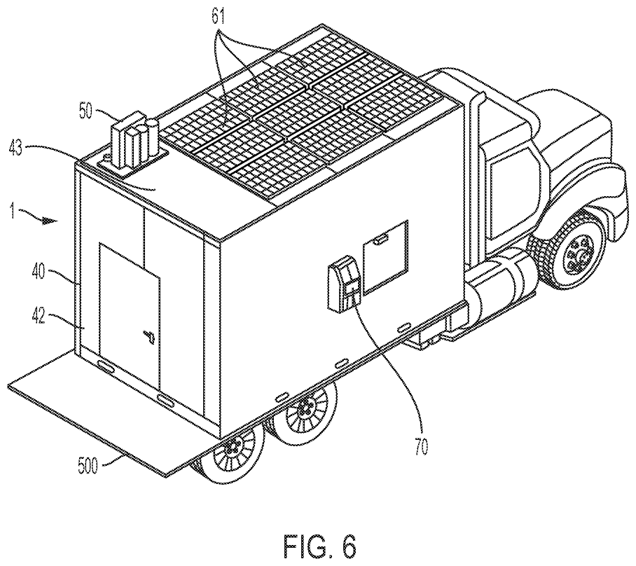

FIG. 6 shows a view of an embodiment of a system (e.g., system 1) for receiving, processing, and storing fish carcasses as loaded onto a truck. The system 1 is shaped and dimensioned to fit onto a truck 500 (e.g., onto a standard flatbed truck). The system 1 can be loaded onto, transported by, and unloaded off of the truck 500—e.g., for distribution or for maintenance. The truck 500 may be a refrigerated truck to keep the contents of the container 40 sufficiently refrigerated to substantially slow meat spoilage during transportation.

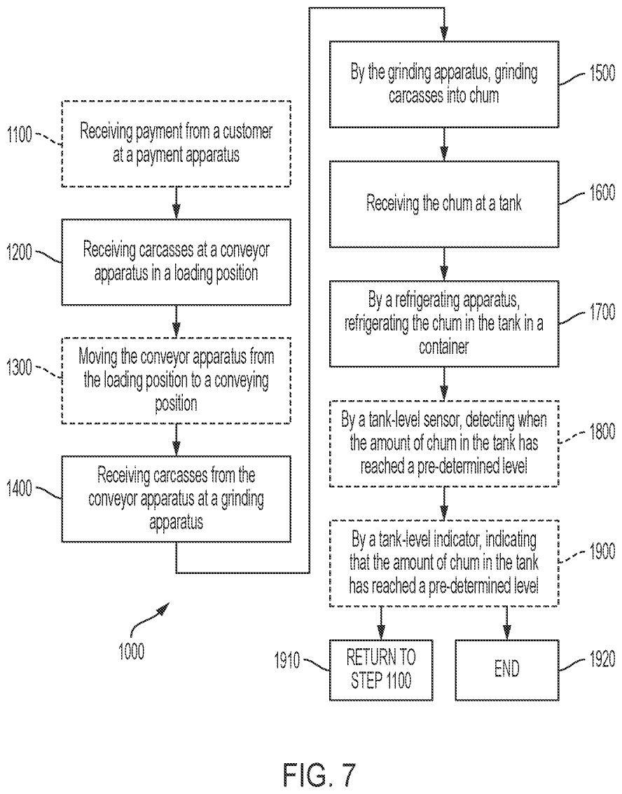

FIG. 7 shows a depiction of a method 1000 of receiving, processing, and storing fish carcasses. The method comprises steps 1200, 1400, 1500, 1600, and 1700. Step 1200 comprises receiving carcasses at a conveyor apparatus 10 in a loading position 102 (see FIG. 2). Step 1400 comprises receiving carcasses from the conveyor apparatus 10 at a grinding apparatus 20 (see FIG. 1). Step 1500 comprises, by the grinding apparatus 20, grinding carcasses into chum (see FIG. 1). Step 1600 comprises receiving the chum at a tank 30 (see FIG. 1). Step 1700 comprises, by a refrigerating apparatus 50, refrigerating the chum in the tank 30 in a container 40 (see FIG. 1).

Some embodiments of the method 1000 may also comprise one or more of the steps 1100, 1300, 1800, and/or 1900. Step 1100 comprises receiving a payment from a customer at a payment apparatus 70 (see FIG. 4). Step 1300 comprises moving the conveyor apparatus 10 from the loading position 102 to a conveying position 101 (see FIG. 2). Step 1800 comprises, by a tank-level sensor 34, detecting when the amount of chum in the tank 30 has reached a pre-determined level (see FIG. 1). Step 1900 comprises, by a tank-level indicator 35, indicating that the amount of chum in the tank 30 has reached a pre-determined level (see FIG. 1).

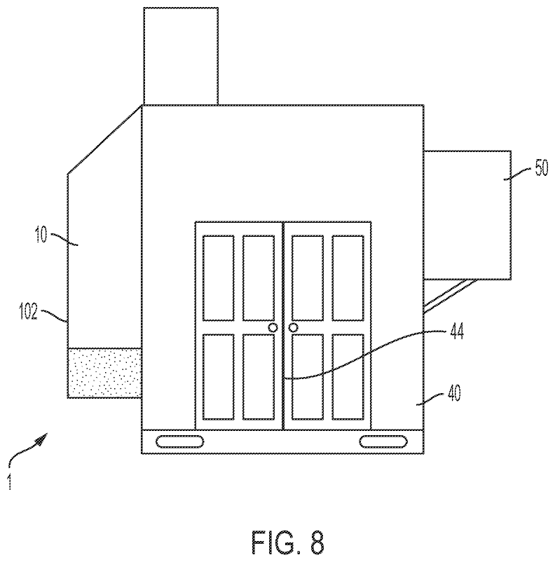

The method 1000 may comprise Step 1910 and/or Step 1920 following the final of Steps 1700, 1800, and 1900. Step 1910 comprises cycling to the beginning of the method by returning to the initial of Steps 1100 and 1200. Step 1920 comprises terminating the method 1000. FIG. 8 is an end view (of the end opposite the end shown in FIG. 3) of the embodiment of the system 1 of FIG. 1, with the conveyor apparatus 10 in a loading position 102. The container 40 comprises a loading door 44. The loading door 44 is configured to allow the tank 30 (see FIG. 1) to be moved into and out of the container 40. The loading door 44 may be any suitable door, for example a double door (as shown in FIG. 12) or a sliding door or an overhead door or a bay door.

While the foregoing specification has described specific embodiments of this invention and many details have been put forth for the purpose of illustration or example, it will be apparent to one skilled in the art that the invention is susceptible to additional embodiments and that certain of the details described herein can be varied considerably without departing from the basic principles of the invention.

What is claimed is:

1. A system for receiving, processing, and storing one or more fish carcasses, comprising:
a conveyor apparatus configured to receive a carcass;
a grinding apparatus configured to receive the carcass from the conveyor apparatus and to grind the carcasses into chum;
a tank configured to receive the chum from the grinding apparatus, wherein the tank is positioned within an interior volume of a container;
a refrigerating apparatus configured to refrigerate the interior volume of the container; and
a power source configured to power the grinding apparatus and the refrigerating apparatus.

2. The system of claim 1, wherein the power source comprises at least one solar panel.

3. The system of claim 1, wherein the grinding apparatus comprises a grinder and a motor configured to drive the grinder.

4. The system of claim 1, wherein the tank is removably and repeatably coupled to the conveyor apparatus.

5. The system of claim 4, wherein the tank comprises at least one skid configured to allow the tank to be moved by a forklift into and out of the container.

6. The system of claim 1, wherein the tank comprises:
a tank-level sensor adapted to detect when an amount of chum in the tank has reached a pre-determined level; and
a tank-level indicator coupled to the tank-level sensor configured to indicate that the tank-level sensor has detected that the amount of chum in the tank has reached the pre-determined level.

7. The system of claim 1, wherein the grinding apparatus and the tank are substantially within the interior volume of the container, and wherein the conveyor apparatus is partially within the interior volume of the container.

8. The system of claim 1, wherein the conveyor apparatus is configured to be movable between a conveying position and a loading position.

9. The system of claim 8, wherein the conveyor apparatus, when in the conveying position, is angled from the horizontal by an angle.

10. The system of claim 9, wherein the angle is approximately seventy degrees.

11. The system of claim 9, wherein the power source is configured to power the conveyor apparatus to move between the conveying position and the loading position.

12. The system of claim 8:
wherein in the conveying position an external chute of the conveyor apparatus is angled from the horizontal by an angle configured to allow a force of gravity to move carcasses through the conveyor apparatus; and
wherein in the loading position the external chute of the conveyor apparatus is positioned such that a loading end of the external chute is in a position to receive carcasses.

13. A system for receiving, processing, and storing fish carcasses, comprising:
a conveyor apparatus configured to receive the carcasses;
a grinding apparatus configured to receive the carcasses from the conveyor apparatus, wherein the grinding apparatus is configured to grind the carcasses into chum;
a tank configured to receive the chum from the grinding apparatus;
a container configured to substantially contain the tank, wherein the container is a substantially closed box;
a refrigerating apparatus configured to refrigerate the contents of the container;
a payment apparatus coupled to the conveyor apparatus and to the grinding apparatus and configured to receive payments; and
a power source configured to power the grinding apparatus, the refrigerating apparatus, and the payment apparatus.

14. The system of claim 13, wherein the power source comprises at least one solar panel.

15. The system of claim 13, wherein the payment apparatus is configured:
to send a signal to the conveyor apparatus to move the conveyor apparatus between a loading position and a conveying position; and
to send a signal to the grinding apparatus to switch the grinding apparatus between an “on” state and an “off” state.

16. The system of claim 13, wherein the tank comprises at least one skid configured to allow the tank to be moved by a forklift into and out of the container.

17. The system of claim 13, wherein the tank comprises:
a tank-level sensor adapted to detect when an amount of chum in the tank has reached a pre-determined level; and
a tank-level indicator coupled to the tank-level sensor configured to indicate that the tank-level sensor has detected that the amount of chum in the tank has reached the pre-determined level.

18. A method of receiving, processing, and storing fish carcasses, comprising:
receiving carcasses at a conveyor apparatus in a loading position;
receiving carcasses from the conveyor apparatus at a grinding apparatus coupled to the conveyor apparatus;
by the grinding apparatus, grinding carcasses into chum;
receiving the chum at a tank coupled to the grinding apparatus; and,
by a refrigerating apparatus, refrigerating the chum in the tank in a container configured to substantially contain the tank,
wherein the refrigerating apparatus is coupled to the container.

19. The method of claim 18, further comprising receiving payment from a customer at a payment apparatus coupled to the conveyor apparatus.

20. The method of claim 18, further comprising:
by a tank-level sensor, detecting when the amount of chum in the tank has reached a pre-determined level; and, by a tank-level indicator, indicating that the amount of chum in the tank has reached the predetermined level.
